(19) United States
(12) Patent Application Publication
(10) Pub. No.: US 2011/0230111 A1
(43) Pub. Date: Sep. 22, 2011

(54) FIBERS CONTAINING ADDITIVES FOR USE IN FIBROUS INSULATION

(76) Inventors: Charles R. Weir, Westerville, OH (US); Harry A. Alter, Granville, OH (US); Yadollah Delaviz, Lewis Center, OH (US); Jeffrey A. Tilton, Shelbyville, KY (US)

(21) Appl. No.: 12/727,776

(22) Filed: Mar. 19, 2010

(51) Int. Cl. B32B 5/02; B32B 27/02; D02G 3/36; B27N 3/04; D04H 3/12; D01D 5/08; D01D 5/34; C08L 101/00; B82Y 30/00

(52) U.S. Cl. 442/362; 442/417; 428/372; 442/364; 442/415; 428/373; 264/109; 264/115; 442/363; 264/172.17; 264/172.15; 524/1; 977/750; 977/752; 977/762; 977/734

(57) ABSTRACT

Polymer fibers having therein at least one infrared attenuating agent is provided. The infrared attenuating agent is at least substantially evenly distributed throughout the polymeric material forming the polymer fibers. In exemplary embodiments, the infrared attenuating agents have a thickness in at least one dimension of less than about 100 nanometers. Alternatively, the polymer fibers are bicomponent fibers formed of a core and a sheath substantially surrounding the core and the infrared attenuating agent is at least substantially evenly distributed throughout the sheath. The modified polymer fibers may be used to form insulation products that utilize less polymer material and subsequently reduce manufacturing costs. The insulation products formed with the modified polymers have improved thermal properties compared to insulation products formed of only non-modified polymer fibers. Additionally, the insulation product is compatible with bio-based binders. Methods of forming the modified polymer fibers and insulation products are also provided.

### TECHNICAL FIELD AND INDUSTRIAL APPLICABILITY OF THE INVENTION

The present invention relates generally to insulation products, and more particularly, to insulation products formed utilizing polymer fibers having incorporated therein infrared attenuating agents. A method of forming these modified polymer fibers is also included.

### BACKGROUND OF THE INVENTION

Fiber insulation is typically formed of mineral fibers (e.g., glass fibers) and/or organic fibers (e.g., polypropylene fibers), bound together by a binder material. The binder material gives the insulation product resiliency for recovery after packaging and provides stiffness and handleability so that the insulation product can be handled and applied as needed in insulation cavities of buildings. During manufacturing, the fiber insulation is cut into lengths to form individual insulation products, and the insulation products are packaged for shipping to customer locations. One typical insulation product is an insulation batt, which is suitable for use as wall insulation in residential dwellings or as insulation in the attic and floor insulation cavities in buildings.

Faced insulation products are installed with the facing placed flat on the edge of the insulation cavity, typically on the interior side of the insulation cavity. Insulation products where the facing is a vapor retarder are commonly used to insulate wall, floor, or ceiling cavities that separate a warm interior space from a cold exterior space. The vapor retarder is placed on one side of the insulation product to retard or prohibit the movement of water vapor through the insulation product.

The thermal conductivity, k, is defined as the ratio of the heat flow per unit cross-sectional to the temperature drop per thickness. The United States defines k by the unit of Formula (I):

$$\frac{Btu \cdot in}{Hr \cdot {Ft}^{2} \cdot ° F .} \qquad Formula ( I )$$

The metric unit is defined by Formula (II):

$$\frac{W}{m \cdot k} \qquad Formula ( II )$$

Reducing the thermal conductivity (k) maximizes the insulating capability (i.e., increases the R-value) for a given thickness. The heat transfer through an insulating material may occur through solid conductivity, gas conductivity, radiation, or convection. The total thermal resistance (R-value), is the measure of the resistance to heat transfer, and is determined by the Formula (III):

R=t/k; where t=thickness Formula (III)

As can be derived from Formula (III), the R-value of an insulation is increased with increased thickness or with decreased k-value. The higher the R-value, the better the insulating properties of the subject materials. Consumers desire an insulation product that is highly insulative yet inexpensive. Accordingly, there exists a need in the art for a fibrous insulation product that maintains the positive physical properties of conventional insulation products and that provides an insulation product with increased insulation value (R-value).

### SUMMARY OF THE INVENTION

It is an object of the present invention to provide a fibrous insulation product that includes a plurality of randomly oriented polymer fibers having therein at least one infrared attenuating agent and a binder interconnecting the polymer fibers. In at least one exemplary embodiment, the binder is a bio-based binder, a carbohydrate-based, a protein-based binder, a vegetable oil-based binder, or a plant oil-based binder. The infrared attenuating agent is at least substantially evenly distributed throughout the polymer fiber. In exemplary embodiments, the infrared attenuating agent has a thickness in at least one dimension of less than about 100 nanometers. The infrared attenuating agent may also have a thickness in other dimensions of less than 100 microns. The insulation products formed using the inventive modified or nano-polymer fibers have improved thermal properties compared to insulation products formed of only non-modified polymer fibers. Additionally, the infrared attenuating agents in the insulation products assist in improving fire performance properties, increasing the oxygen index, and decreasing the flame spread, which helps to meet stringent fire requirements.

It is also an object of the present invention to provide a fiber that includes a polymeric material having therein at least one infrared attenuating agent. The infrared attenuating agent may be substantially evenly distributed throughout the polymeric material. In exemplary embodiments, the infrared attenuating agent has a thickness in at least one dimension of less than about 100 nanometers. In addition, the infrared attenuating agent may be embedded within the polymer fiber with little or no portion of the infrared attenuating agents penetrating the surface of the fiber. In at least one exemplary embodiment, the infrared attenuating agent is fully embedded within the polymer material. The fiber may also include glass fibers, natural fibers, synthetic fibers, mineral fibers, carbon fibers and ceramic fibers within the polymer material.

It is a further object of the present invention to provide a fibrous insulation product that includes a plurality of randomly oriented bicomponent fibers formed of first polymer fibers and second polymer fibers where the first polymer fibers have a melting point below a melting point of the second polymer fibers. The bicomponent fibers have at least one infrared attenuating agent distributed throughout at least one of the first polymer fibers and the second polymer fibers. The infrared attenuating agent may be substantially evenly distributed throughout one or both of the first polymer fibers and the second polymer fibers. Additionally, the first polymer fibers provide a polymer matrix that interconnects the second polymer fibers and the first polymer fibers. The bicomponent fibers may be arranged as a sheath-core, side-by-side, islands-in-the-sea, segmented-pie arrangement, pie-wedge configuration, or combinations thereof. In at least one exemplary embodiment, the bicomponent fiber is a sheath-core fiber formed of first polymer fibers and second polymer fibers and the second polymer fibers at least substantially evenly surrounds the first polymer fibers. The infrared attenuating agent may have a thickness in one dimension less than about 100 nanometers and a thickness in other dimensions of less then about 100 microns. Further, the insulation product may further include at least one member selected from glass fibers, natural fibers, synthetic fibers, mineral fibers, carbon fibers, ceramic fibers, dual glass bicomponent fibers, and pure polymer fibers.

It is yet another object of the present invention to provide a method of manufacturing a fiberglass insulation product that includes (1) supplying a plurality of polymeric fibers having therein at least one infrared attenuating agent, where the infrared attenuating agent is at least substantially evenly distributed throughout each polymer fiber, (2) binding at least a portion of the polymeric fibers, (3) collecting the binder coated polymeric fibers on a conveying apparatus to form a fibrous pack, and (4) heating the fibrous pack to dry the polymer fibers and at least partially cure the binder and form the insulation product. In exemplary embodiments, the supplying step includes feeding a polymer material and at least one infrared attenuating agent into an extruder and then extruding the polymer material and at least one attenuating agent into the plurality of polymer fibers. In addition, the method may include compounding the infrared attenuating agent in a polymer carrier, pelletizing the compounded infrared attenuating agent to form a pellet, and supplying the pellet and the polymer material to the extruder. In at least one exemplary embodiment, the pellet and the polymer material are added to the extruder at substantially the same time. The infrared attenuating agent may have a thickness in at least one dimension of less than about 100 nanometers. Additionally, the insulation product may further include at least one member selected from glass fibers, natural fibers, synthetic fibers, mineral fibers, carbon fibers, ceramic fibers, dual glass bicomponent fibers and polymer fibers.

It is a further advantage of the present invention to provide a method of manufacturing a fiberglass insulation product that includes (1) feeding a first polymer material and at least one infrared attenuating agent into a first extruder, (2) supplying a second polymer material to a second extruder, and (3) co-extruding the polymer material and the at least one attenuating agent with the second polymer material to form the bicomponent fiber. In at least one exemplary embodiment, the first polymer material and the at least one infrared attenuating agent form a sheath and the second polymer material forms a core. The method may also include compounding the at least one infrared attenuating agent in a polymer carrier, pelletizing the compounded infrared attenuating agent to form a pellet, and supplying the pellet and the polymer material to the first extruder at substantially the same time. The infrared attenuating agent may have a thickness in at least one dimension of less than about 100 nanometers. Additionally, the insulation product may further include at least one member selected from glass fibers, natural fibers, synthetic fibers, mineral fibers, carbon fibers, ceramic fibers, dual glass bicomponent fibers and polymer fibers.

It is an advantage of the present invention that energy absorbent or reflective additives present in the insulation product increase the R-value of the insulation.

It is another advantage of the present invention that the polymer content of the insulation is reduced by the incorporation of infrared attenuating agents in the polymer fibers.

It is a further advantage of the present invention that insulation products formed using the inventive nano-polymer fibers have improved thermal properties compared to insulation products formed of only polymer fibers.

It is also an advantage of the present invention that the infrared attenuating agents can be incorporated into the external sheath of a bicomponent fiber.

It is another advantage of the present invention that the inclusion of infrared attenuating agents into the polymer fiber does not hinder the ability of the insulation to recover high loft thicknesses.

It is an additional advantage of the present invention that the insulation product has a soft hand.

It is a further advantage of the present invention that the infrared attenuating agents can be substantially uniformly distributed within the polymer fiber.

It is also an advantage of the present invention that the infrared attenuating agents improve the ultraviolet (UV) stability of the polymer fiber.

It is an additional advantage of the present invention that the infrared attenuating agent, such as nanographite and clay, enhance the thermal stability and reduces flammability of the composite product.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of an extrusion apparatus for forming nano-polymer fibers according to at least one exemplary embodiment of the invention;

FIG. 2 is a schematic illustration of a co-extrusion apparatus for forming bi-component nano-polymer fibers according to another exemplary embodiment of the invention;

FIG. 3 is a schematic illustration of a manufacturing line for producing a faced fibrous insulation product in which the faced insulation product is rolled by a roll-up device according an exemplary embodiment of the present invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

In the drawings, the thickness of the lines, layers, and regions may be exaggerated for clarity. It is to be noted that like numbers found throughout the figures denote like elements. It will be understood that when an element is referred to as being “on,” another element, it can be directly on or against the other element or intervening elements may be present. The terms “polymer fiber” and “polymeric fiber” may be used interchangeably herein.

The present invention relates to the incorporation of infrared attenuating agents within the body of a polymer fiber. The utilization of these modified polymer fibers (“nano-polymer fibers”) to form insulation products permits for a reduction in the polymer content in the insulation and a reduction in manufacturing costs. In addition, insulation products formed using the inventive modified or nano-polymer fibers have improved thermal properties compared to insulation products formed of only non-modified polymer fibers. The infrared attenuating agents in the insulation products assist, for example, in improving fire performance properties such as char formation, increasing the oxygen index, and decreasing the flame spread, which helps to meet stringent fire requirements.

The polymeric resin provides strength, flexibility, toughness and durability to the insulation product. The polymeric resin may be in the form of a flake, granule, pellet, and/or powder. The polymeric resin is not particularly limited, and suitable polymeric resins may include, but are not limited to, polyethylene, polypropylene, polyethylene terephthalate (PET), polyesters, epoxy resins, polyvinyl chloride (PVC), chlorinated polyvinyl chloride (CPVC), polycarbonates, polyamides, polyaramides, polyimides, polyester elastomers, acrylic acid esters, copolymers of ethylene and propylene, copolymers of styrene and butadiene, copolymers of vinylacetate and ethylene, and combinations thereof. In addition, the polymeric resin may be post industrial or consumer grade (e.g., regrind). The nano-polymer fiber may include one or more polymeric resin. In exemplary embodiments, the polymer resin is polyethylene terephthalate or polypropylene. The polymer resin may be present in the nano-polymer fiber in an amount from about 90.0% to about 99.9%, from about 95.0% to about 99.9%, from about 99.5% to about 99.9%, or from about 98.0% to about 99.9%.

The infrared attenuating agent may be incorporated into the polymeric material in an extrusion process that at least substantially evenly disperses the infrared attenuating agents within the polymer resin, and thus within the formed polymer fibers. The infrared attenuating agent(s) may be compounded in a polymer prior to the addition of the infrared attenuating agent to an extruder. The compounding polymer may or may not be the same as the polymeric resin discussed above, which forms the majority of the nano-fiber fiber body. Accordingly, the infrared attenuating agent may be compounded in a carrier such as polypropylene or polyethylene terephthalate, pelletized, and added to an extruder as discussed below. Alternatively, the infrared attenuating agent may be added to the extruder directly, for example, as a powder, in a compact form, in a slurry, or in a paste.

The infrared attenuating agent is not particularly limited, and may include any infrared attenuating agent known to those of skill in the art. The infrared attenuating agents may be materials that do not readily intermix with the polymer material. In addition, the infrared attenuating agents retain their integrity within the polymer fiber, and do not melt or otherwise change in shape or form. Non-limiting examples of suitable infrared attenuating agents for use in the present composition include graphite, nanographite, carbon black, powdered amorphous carbon, asphalt, granulated asphalt, milled glass, fiber glass strands, mica, black iron oxide, metal flakes (e.g., aluminum flakes), nanographene platelets, carbon nanotubes (both single and multi-walled), carbon nanofiber, activated carbon, metal oxides (e.g., titanium dioxide, aluminum oxide, etc.), and combinations thereof. In exemplary embodiments, the infrared attenuating agent is “nano-sized” or a “nanoparticle”. As used herein, the terms “nano-sized” or “nanoparticle” are intended to denote compounds that have a thickness in at least one dimension, most likely the thickness of the compound or particle, of less than about 100 nanometers. The infrared attenuating agents may be mechanically treated, such as by air jet milling, to pulverize the infrared attenuating agent to achieve a thickness in other dimensions of less than about 100 microns, or less than 20 microns, and most likely less than about 5 microns. One or more infrared attenuating agent (including nano-sized infrared attenuating agents) may be used to form the nano-polymer fiber. The infrared attenuating agent may be present in the nano-polymer fiber in an amount from about 0.01% to about 10.0%, from about 0.1% to about 5.0%, or from about 0.1% to about 1.0%.

In at least one exemplary embodiment, the infrared attenuating agent is nanographite, which may be synthetic or natural and may or may not be surface modified. In some exemplary embodiments, the nanographite may be intercalated, exfoliated, or multilayered, such as by furnace high temperature expansion from acid-treated natural graphite or microwave heating expansion from moisture saturated natural graphite. Additionally, the nanographite may be chemically treated (e.g., by grafting) to include carboxyl and phenolic hydroxyl functional groups on the graphite edge. The nanographite may also be further grafted with other functional groups such as, for example, to form an acid treated graphite containing carboxylic acid groups on the carbon surface and further functionalized with glycidyl methacrylate (GMA) to improve dispersion of the resulting graphite in the polymer matrix.

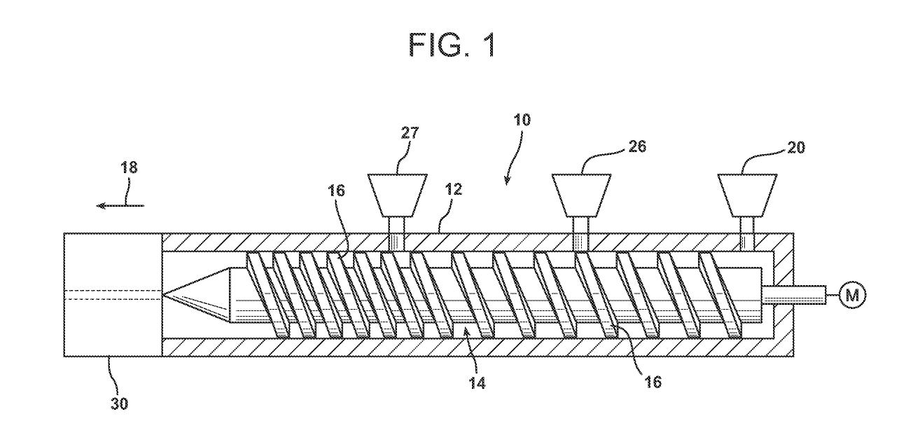

A screw extruder for use in the present invention is generally indicated at reference numeral 10 in FIG. 1. The screw extruder for use in the instant invention may equally be a single screw or twin screw extruder, reference is made herein with respect to a single screw extruder. The extruder 10 is formed of a barrel 12 and at least one screw 14 that extends substantially along the length of the barrel 12. A motor (M) may be used to power the screw 14. The screw 14 contains helical flights 16 rotating in the direction of arrow 18.

In operation, the polymeric resin and infrared attenuating agent are added to the extruder 10 so that the infrared attenuating agent can be homogenously mixed within the polymer resin. It is to be appreciated that the flights 16 of the screw 14 cooperate with the cylindrical inner surface of the barrel 12 to define a passage for the advancement of the polymer melt through the barrel 12. In one exemplary embodiment, the polymer resin and the infrared attenuating agent are substantially simultaneously fed into the barrel 12 of the extruder 10 through hopper 20. As used herein, the term “substantially simultaneously fed” is meant to indicate that the polymer material and the infrared attenuating agent are fed into the barrel 12 at the same time or at nearly the same time. If the infrared attenuating agent is not compounded with a polymer and formed into a flowable solid, such as a pellet, and is instead in the form of a powder or flake, the infrared attenuating agent may be metered into the barrel 12 by a metering apparatus, such as an auger or crammer (not shown), to force the resin into the barrel 12 against the rotating action of the screw 14. It is conceivable that color pellets may be fed into the extruder 10 from a color pellet hopper (not shown) to give the final product (i.e., fibers) a desired color or appearance rather than, or in addition to, adding a colorant to through the hopper 20.

Once the polymer material and the infrared attenuating agent are added to the barrel 12 of the extruder 12, mechanical action and friction generated by the screw 14 (optionally with the assistance of external heaters 22) melt the polymeric resin and mix and/or compound the resin and infrared attenuating agent into a substantially homogeneous mixture. The resin/infrared attenuating agent mixture is conveyed from the extruder 10 as an extrudate into a die 30 which is designed to shape the extrudate into individual polymeric fibers. A breaker plate, screen or adapter (not shown) may be used to transition the extrudate from the extruder 10 to the die (spinneret) 30. In the adapter, the extrudate is collected as it exits the extruder 10 and is re-shaped so that it may be fed into the die 30 as a solid and continuous slug. The die (spinneret) 30 may be of any shape, such as, for example, a rectangle, sheet, or square. It is within the purview of this invention to include one or more dies or spinnerets 30 arranged in series to achieve the desired fiber product. The resin/infrared attenuating agent mixture is passed from the extruder through the one or more dies to form individual polymeric fibers having substantially homogenously mixed therein one or more infrared attenuating agent. In at least one exemplary embodiment, the infrared attenuating agent is embedded within the polymer fiber with little or no portion of the infrared attenuating agents penetrating the surface of the fiber. In a further embodiment, the infrared attenuating agents are completely embedded within the polymer matrix.

In an alternate embodiment, the polymeric resin and the infrared attenuating agent are added to the barrel 12 of the extruder 10 at different locations. For instance, the polymeric resin may be added at hopper 20 and the infrared attenuating agent may be added at hopper 26. As depicted in FIG. 1, hopper 22 is positioned downstream from hopper 20. The term “downstream” as used herein refers to the direction of resin and fiber flow through the barrel 12. Thus, in this embodiment, the polymeric resin (and optional colorant) is added independently of the infrared attenuating agent. By adding the polymeric resin prior to the addition of the infrared attenuating agent, the polymeric resin is at least partially melted by the mechanical action of the screw 14 before it is mixed with the infrared attenuating agent. This “pre-melting” permits for an easier mixing of the resin and the reinforcement infrared attenuating agent into a substantially homogenous mixture. In addition, when adding the infrared attenuating agents downstream of the polymer resin, it may be advantageous to utilize a longer extrusion apparatus than used when the resin mixture and reinforcement fibers are added together through a hopper (e.g., hopper 20) to permit thorough mixing (compounding) of the resin and infrared attenuating agent. As discussed above, the resin/infrared attenuating agent mixture is passed from the extruder through one or more dies to form individual polymeric fibers having substantially homogenously mixed therein one or more infrared attenuating agent.

The nano-polymer fibers may then be gathered into strands or tubes and these collected fibers may be stored for later use. The nano-polymer fibers may also or alternatively be subjected to various chemical treatments and/or coatings, depending on the desired end use. In some embodiments, the fibers may be sized, gathered, chopped, and/or crimped, compressed into a bale, and stored for later use. When chopped, these modified polymer fibers may have a length from about 0.25 to about 6.0 inches or from about 0.75 to about 6.0 inches. Typically, the fibers have a diameter from about 4.0 to about 100.0 microns or from about 6.0 to about 50.0 microns. Fibers that are capable of splitting via mechanical or chemical means either during or after web formation can have diameters from 0.1 to 10 microns.

In another exemplary embodiment of the invention, reinforcing fibers such as glass fibers (e.g., A-type glass fibers, C-type glass fibers, E-type glass fibers, S-type glass fibers, AR type glass fibers, AF-type glass fibers, or modifications thereof), natural fibers (e.g., cellulosic fibers), synthetic fibers, mineral fibers, carbon fibers, ceramic fibers may be added to the barrel 12 of the extruder 10 downstream addition of the addition of the infrared attenuating agent, such as by hopper 27. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber material include basalt, cotton, jute, bamboo, ramie, bagasse, hemp, coir, linen, kenaf, sisal, flax, henequen, cellulosic, and combinations thereof.

Other examples of suitable fibers for addition to the polymer fibers in the insulation product include rayon, aramid, nylon, acrylic, olefin, saran, acetate, and/or triacetate fibers. A further example of a reinforcing fiber suitable for use in the insulation product is a dual glass fiber sold under the trade name Miraflex™ and manufactured by Owens-Corning Fiberglas Technology, Inc. The bicomponent fiber is formed of fibers of different glass formulations, which cause the fiber to curl and twist. Such curling and twisting of the dual glass fiber offers increased loft and improved insulative performance to the insulation product. The dual glass, bicomponent fiber, in a “relaxed” state, may have lengths from about 0.5 inches to about 2.0 inches. The reinforcing fibers are compounded and mixed with the polymer resin and infrared attenuating agent to form a substantially homogenous mixture, which is conveyed as an extrudate to the spinneret/die 30 and formed into individual polymer/reinforcement composite fibers.

The reinforcement fibers may be present in the modified fiber in an amount from about 0 to about 100% by weight of the modified fiber, or from about 1.0% to about 50.0% by weight of the modified fiber. Although fiber lengths of any convenient size for processing in an extruder may be used, the reinforcing fibers preferably have diameters ranging from about 4.0 to about 100.0 microns or about 6.0 to about 50.0 microns and lengths from about 6.0 to about 150 mm or from about 19.0 to about 75.0 mm.

In yet another exemplary embodiment of the invention, the nano-polymer fiber may be a multicomponent fiber such as bicomponent fibers or tricomponent fibers formed of at least two different polymers. For instance, bicomponent fibers may be formed of two polymers combined to form fibers having a core of one polymer and a surrounding sheath of the other polymer. In particular, the bicomponent fibers may be arranged in a sheath-core, side-by-side, islands-in-the-sea, or segmented-pie arrangement. A further example of a bicomponent fiber may be referred to as a “splittable” bicomponent or “pie wedge” fiber. This “splittable” fiber is produced with at least two polymer components as described above with respect to other multicomponent fibers; however, the polymers are dissimilar so as to create a weak link within the fiber. The “splittable” fibers may be characterized by their ability to break into numerous, smaller segments by either mechanical or chemical means. The infrared attenuating agent can be positioned within one or within more than one of the polymer fibers forming the multicomponent fibers.

Numerous combinations of materials can be used to make the bicomponent polymer fibers, such as, but not limited to, combinations using polyester, polypropylene, polysulfide, polyolefin, and polyethylene fibers. Specific polymer combinations for the bicomponent fibers include polyethylene terephthalate/polypropylene, polyethylene terephthalate/polyethylene, and polypropylene/polyethylene. Other non-limiting bicomponent fiber examples include copolyester polyethylene terephthalate/polyethylene terephthalate (coPET/PET), poly 1,4 cyclohexanedimethyl terephthalate/polypropylene (PCT/PP), high density polyethylene/polyethylene terephthalate (HDPE/PET), high density polyethylene/polypropylene (HDPE/PP), linear low density polyethylene/polyethylene terephthalate (LLDPE/PET), nylon 6/nylon 6,6 (PA6/PA6,6), and glycol modified polyethylene terephthalate/polyethylene terephthalate (6PETg/PET).

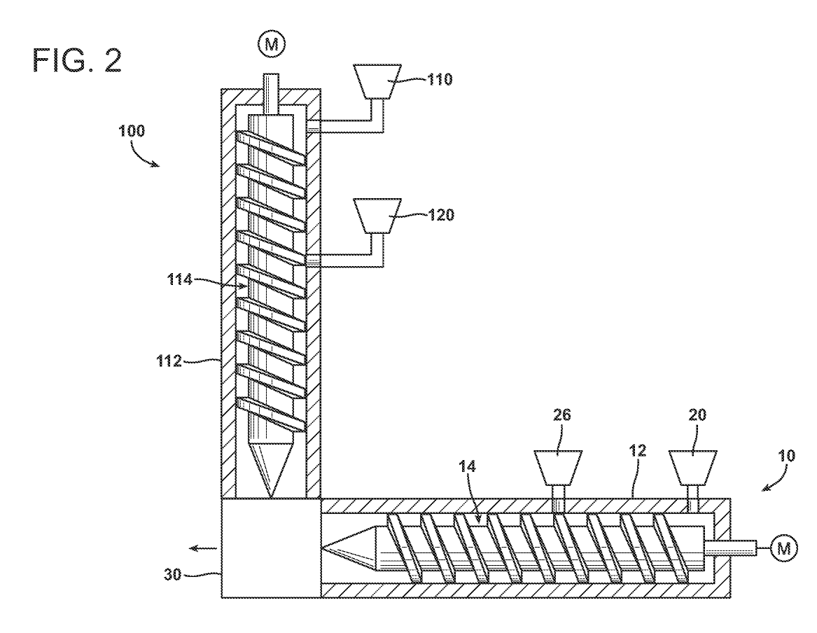

In one or more exemplary embodiment, the bicomponent fibers are formed in a sheath-core arrangement in which the sheath is formed of first polymer fibers which substantially surround the core formed of second polymer fibers. It is to be appreciated that the external sheathing (as well as the bicomponent fiber itself) may vary in thickness and concentration of the infrared attenuating agent(s) depending on desired product performance, application, and cost. It is not required that the sheath fibers totally surround the core fibers. In exemplary embodiments, the infrared attenuating agent is positioned throughout the sheath of a sheath/core bicomponent fiber or in one or both “sides” of a bicomponent fiber having a side-by-side configuration. It is envisioned that the infrared attenuating agent may be positioned in the core or in both the core and the sheath. Reference will be made herein to the infrared attenuating agent being positioned in the sheath of the bicomponent fiber. The bicomponent nano-polymer fiber may be formed by a co-extrusion process whereby the sheath is formed from a polymer/infrared attenuating agent extrudate from a first extruder and the core is formed of a polymer material from a second extruder. FIG. 2 illustrates one such exemplary embodiment.

As illustrated in FIG. 2, a secondary extruder 100 may be positioned in the extrusion line at a location such that the resin/infrared attenuating agent mixture formed in extruder 10 and a molten polymer material formed in the secondary extruder 100 exit the die/spinneret 30 together. The resin/infrared attenuating agent mixture may be formed in accordance with the description set forth above with respect to FIG. 1. With respect to the molten polymer material, a polymer material may be fed into a hopper 110 positioned on the barrel 112 of the secondary extruder 100. The hopper 110 conveys the polymer material to the barrel 112 of the extruder 100. As the polymer material is passed through the secondary extruder 100, the mechanical action of the screw 114 and the subsequently generated heat causes the polymer material to melt and form a molten polymer material. Additional hoppers, such as hopper 120, may be positioned on the barrel 112 of the extruder 100 to convey additional components to the barrel 112 to impart desired properties. The molten polymer material from the secondary extruder 100 and the resin/infrared attenuating agent mixture from extruder 100 are conveyed to the spinneret/die 30 where the molten materials are co-extruded into bi-component fibers. In particular, the spinneret/die 30 may be configured such that the polymer material from extruder 100 forms the core and the resin/infrared attenuating agent mixture from the primary extruder 10 forms the sheath of the nano-polymer bicomponent fibers. In this embodiment, the infrared attenuating agent is substantially homogenously distributed throughout the polymer sheath.

In one exemplary embodiment, the nano-polymer fibers and/or nano-polymer bicomponent fibers are used to form a fibrous insulation product that has improved R-value over conventional fibrous insulation that does not contain any infrared attenuating agents. It is to be appreciated that the polymeric fibrous insulation product may be formed in-line following the formation of the nano-polymer fibers or off-line using nano-fibers that have been stored and chemically treated. For example, nano-polymer fibers, having been chemically treated (e.g., with a sizing composition) and chopped into suitable lengths, may be randomly distributed on an endless conveyor with the aid of a vacuum drawn through the mat from below the forming conveyor. In at least one exemplary embodiment, a binder may be applied in a manner so as to result in a distribution of the binder throughout the formed insulation pack described in detail below.

The binder utilized may be a polycarboxylic acid based binder such as a polyacrylic acid glycerol (PAG) binder or a polyacrylic acid triethanolamine (PAT) binder. Such binders are known for use in connection with rotary fiberglass insulation. Examples of such binder technology are found in U.S. Pat. Nos. 5,318,990 to Straus; 5,340,868 to Straus et al.; 5,661,213 to Arkens et al.; 6,274,661 to Chen et al.; 6,699,945 to Chen et al.; and 6,884,849 to Chen et al., each of which is expressly incorporated entirely by reference. Conventional binders such as, but not limited to, phenol-formaldehyde binders and urea-formaldehyde binders may also be suitable for use in the present invention. It is also envisioned that a bio-based binder, a carbohydrate-based binder (e.g., starch- and/or sugar-based binder), a protein-based binder (e.g., soy-based binder), a vegetable oil-based binder, a plant oil-based binder, a urethane-based binder, and/or a furan-based binder may be suitable for use in the present invention. In one or more exemplary embodiment, the binder is a low-formaldehyde, polyacrylic acid-based binder. It is to be understood that the binder may alternatively be a thermoset or thermoplastic polymer in the form of a powder or flake or a bicomponent fiber where one of the polymer fibers forming the bicomponent fibers forms a matrix to bind the fibers, such as is described in detail below. The binder may be present in the insulation product in an amount from about 1.0% to about 20.0% by weight of the insulation product, and in exemplary embodiments, from about 1.0% to about 10.0% by weight of the insulation product or from about 5.0% to about 8.0% by weight of the insulation product.

The binder composition may optionally contain conventional additives such as pigments, dyes, colorants, oils, fillers, thermal stabilizers, emulsifiers, anti-foaming agents, anti-oxidants, organosilanes, colorants, and/or other conventional additives. Other additives may be added to the binder composition for the improvement of process and product performance. Such additives include coupling agents (e.g., silane, aminosilane, and the like), dust suppression agents, lubricants, wetting agents, surfactants, antistatic agents, and/or water repellent agents.

In one or more exemplary embodiment, one of the polymers forming the bicomponent fibers acts as a binder to hold the fibers in the insulation product together. In bicomponent fibers, the first polymer fibers have a melting point that is lower than the melting point of the second polymer fibers so that upon heating the bicomponent fibers, the first and second polymer fibers react differently, thus enabling the first polymer fibers to act as a binder. For instance, when the bicomponent fibers are heated to a temperature that is above the melting point of the first polymer fibers (e.g., sheath fibers) and below the melting point of the second polymer fibers (e.g., core fibers), the first polymer fibers will soften or melt while the second polymer fibers remain intact. This softening of the first polymer fibers (sheath fibers) will cause the first polymer fibers to become sticky and bond the first polymer fibers to themselves and other fibers that may be in close proximity. In such an embodiment, there is no need for any additional binder material, such as, for example, the binders discussed above.

The presence of water, dust, and/or other microbial nutrients in the insulation product may support the growth and proliferation of microbial organisms. Bacterial and/or mold growth in the insulation product may cause odor, discoloration, and deterioration of the insulation product, such as, for example, deterioration of the vapor barrier properties of the Kraft paper facing. To inhibit the growth of unwanted microorganisms such as bacteria, fungi, and/or mold in the insulation product, the insulation pack may be treated with one or more anti-microbial agents, fungicides, and/or biocides. The anti-microbial agents, fungicides, and/or biocides may be added during manufacture or in a post manufacture process of the insulation product.

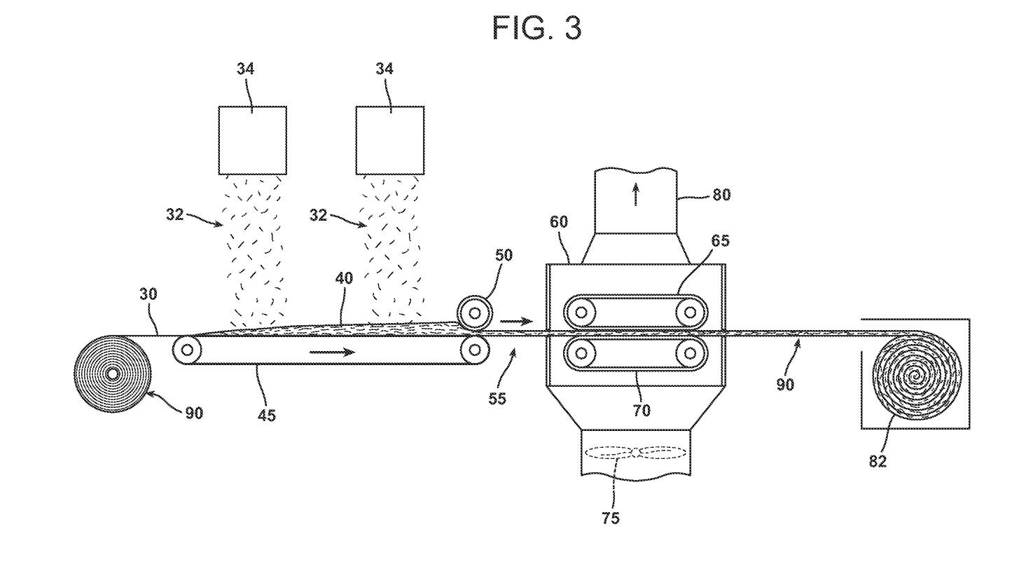

Turning to FIG. 3, nano-polymer fibers 32 having the uncured resinous binder adhered thereto may be gathered and formed into an uncured pack 40 on a facer 30 on an endless forming conveyor 45 with the aid of a vacuum (not shown) drawn through the insulation pack 40 from below the forming conveyor 45. The nano-polymer fibers 32 may be dispensed from one or more dispensing apparatus 34 or dispensed directly from a bale of nano-particle fibers utilizing a conventional bale opener (not shown). Optionally, other reinforcing fibers such as glass fibers, natural fibers, mineral fibers, carbon fibers, ceramic fibers, dual glass fibers, and/or pure synthetic fibers such as polyester, polyethylene, polyethylene terephthalate, polypropylene, polyamide, aramid, and/or polyaramid fibers may be present in the insulation product in addition to the nano-polymer fibers. The term “synthetic fibers” as used herein is meant to indicate any man-made fiber having suitable reinforcing characteristics. One or more reinforcing fibers or reinforcing materials may be utilized to form the final insulation product. In at least one embodiment, the reinforcement fibers are dry chopped glass fibers.

The facing material may be recycled paper, calendared paper, conventional Kraft paper, or some other facing material known to those of skill in the art. It is to be noted that the facer(s) may be facing materials having thereon a pre-applied adhesive. Alternatively, an asphalt coating may be used both to adhere the insulation product to the Kraft paper facing and to provide vapor barrier properties to the paper. For instance, an asphalt layer may be applied in molten form and pressed against the fibrous insulation material before hardening to bond the Kraft facing material to the insulation material. As illustrated in FIG. 3, the facer 92 may be supplied to the conveyor 45 by roll 90.

The pack 40 and facer 92 are then heated, such as by conveying the pack 40 through a curing oven 60 where heated air is blown through the insulation pack 40 and facer 12 to evaporate any remaining water in the binder, cure the binder and the adhesive, rigidly bond the fibers together in the insulation pack 40, and adhere the facer 92 to the insulation pack 40. The facer 92 and the insulation pack 40 are heated to a temperature at or above the temperature of the adhesive for a time period sufficient to at least partially melt the adhesive and bond the adhesive to the insulation pack 40. The cured binder helps to impart strength and resiliency to the insulation product. It is to be appreciated that the drying and curing of the binder may be carried out in either one or two different steps (B-staging).

Specifically, heated air is forced though a fan 75 through the lower oven conveyor 70, the insulation pack 40, the upper oven conveyor 65, and out of the curing oven 60 through an exhaust apparatus 80. The cured binder imparts strength and resiliency to the faced insulation product 90. Also, in the curing oven 60, the pack 40 may be compressed by upper and lower foraminous oven conveyors 65, 70 to form a faced insulation product 90 having a predetermined thickness. It is to be appreciated that the drying and curing of the binder and the waterless, thin-film adhesive may be carried out in either one or two different steps. The distance between the lower flight of the belt 65 and the upper flight of the belt 70 determines the thickness of the fibrous pack 40. It is to be appreciated that although FIG. 3 depicts the conveyors 60, 70 as being in a substantially parallel orientation, they may alternatively be positioned at an angle relative to each other.

The faced fibrous insulation 90 may then exit the curing oven 60 and may be rolled by roll-up device 82 for storage and/or shipment. The faced fibrous insulation product 90 may subsequently be unrolled and cut. Alternatively, the faced fibrous insulation product 90 may be cut to a predetermined length by a cutting device such as a blade or knife to form panels of the faced fibrous insulation (not illustrated).

The modified fibers of the present invention posses numerous advantages. For example, the utilization of the inventive polymer fibers to form insulation products permits for a reduction in the polymer content in the insulation and a subsequent reduction in manufacturing costs. In addition, the insulation products formed using the inventive polymer fibers have improved thermal properties compared to insulation products formed of only non-modified polymer fibers. Additionally, the energy absorbent or reflective additives present in the insulation product increase the R-value of the insulation. Further, the infrared attenuating agents in the insulation products assist in improving fire performance properties such as char formation, increasing the oxygen index, and decreasing the flame spread, which helps to meet stringent fire requirements. In addition, the infrared attenuating agents improve the ultraviolet (UV) stability of the polymer fiber. Also, when nanographite is used as the infrared attenuating agent, the fiber possesses a light gray or platinum color.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A fibrous insulation product comprising:
a plurality of randomly oriented polymer fibers having therein at least one infrared attenuating agent, said infrared attenuating agent being at least substantially evenly distributed throughout said polymer fiber; and
a binder interconnecting at least a portion of said fibers.

2. The fibrous insulation product of claim 1, wherein said at least one infrared attenuating agent has a thickness in at least one dimension of less than about 100 nanometers.

3. The fibrous insulation product of claim 2, wherein said at least one infrared attenuating agent has a thickness in other dimensions of less than about 100 microns.

4. The fibrous insulation product of claim 2, wherein said at least one infrared attenuating agent is selected from nanographite, nanographene platelets, carbon nanotubes, carbon nanofiber and combinations thereof.

5. The fibrous insulation product of claim 1, wherein said at least one infrared attenuating agent is selected from graphite, nanographite, carbon black, powdered amorphous carbon, asphalt, granulated asphalt, milled glass, fiber glass strands, mica, black iron oxide, metal flakes, nanographene platelets, single walled carbon nanotubes, multi-walled carbon nanotubes, carbon nanofibers, activated carbon, metal oxides and combinations thereof.

6. The fibrous insulation product of claim 1, wherein said binder is selected from a bio-based binder, a carbohydrate-based, a protein-based binder, a vegetable oil-based binder and a plant oil-based binder.

7. The fibrous insulation product of claim 1, further comprising at least one member selected from glass fibers, natural fibers, synthetic fibers, mineral fibers, carbon fibers ceramic fibers and dual glass bicomponent fibers.

8. The fibrous insulation product of claim 1, wherein said polymer fibers are bicomponent fibers formed of a core and a sheath substantially surrounding said core, and
wherein said at least one infrared attenuating agent is at least substantially evenly distributed throughout said sheath.

9. A fiber comprising:
a polymeric material having therein at least one infrared attenuating agent, said infrared attenuating agent being at least substantially evenly distributed throughout said polymeric material.

10. The polymer fiber of claim 9, wherein said at least one infrared attenuating agent has a thickness in at least one dimension of less than about 100 nanometers.

11. The polymer fiber of claim 10, wherein said at least one infrared attenuating agent is fully embedded within said polymer material.

12. The polymer fiber of claim 9, further comprising at least one member selected from glass fibers, natural fibers, synthetic fibers, mineral fibers, carbon fibers and ceramic fibers within said polymer material.

13. The polymer fiber of claim 9, wherein said polymer fiber is a bicomponent fiber formed of a core and a sheath substantially surrounding said core, and
wherein said at least one infrared attenuating agent is at least substantially evenly distributed throughout said sheath.

14. A method of manufacturing a fiberglass insulation product comprising:
supplying a plurality of polymeric fibers having therein at least one infrared attenuating agent, said infrared attenuating agent being at least substantially evenly distributed throughout each said polymer fiber;
binding at least a portion of said polymeric fibers;
collecting said binder coated polymeric fibers on a conveying apparatus to form a fibrous pack; and
heating said fibrous pack to dry said polymeric fibers and at least partially cure said binder and form said fiberglass insulation product.

15. The method of claim 14, wherein said supplying step comprises:
feeding a polymer material and at least one infrared attenuating agent into an extruder;
extruding said polymer material and said at least one attenuating agent into said plurality of polymer fibers.

16. The method of claim 15, further comprising:
compounding said at least one infrared attenuating agent in a polymer carrier;
pelletizing said compounded infrared attenuating agent to form a pellet; and
supplying said pellet and said polymer material to said extruder at substantially the same time.

17. The method of claim 14, wherein said at least one infrared attenuating agent has a thickness in at least one dimension of less than about 100 nanometers.

18. The method of claim 14, further comprising:
adding to said extruder at least one member selected from glass fibers, natural fibers, synthetic fibers, mineral fibers, carbon fibers, ceramic fibers and dual glass bicomponent fibers.

19. A fibrous insulation product comprising:
a plurality of randomly oriented bicomponent fibers having first polymer fibers and second polymer fibers, said first polymer fibers having a melting point below a melting point of said second polymer fibers; and
at least one infrared attenuating agent distributed throughout at least one of said first polymer fibers and said second polymer fibers,
wherein said first polymer fibers provide a polymer matrix that interconnects said second polymer fibers and said first polymer fibers.

20. The fibrous insulation product of claim 19, wherein said bicomponent fibers are arranged as a sheath-core, side-by-side, islands-in-the-sea, segmented-pie arrangement, pie-wedge configuration or combinations thereof.

21. The fibrous insulation product of claim 20, wherein said bicomponent fiber is a sheath-core fiber formed of said first polymer fibers and said second polymer fibers, said second polymer fibers at least substantially surrounding said first polymer fibers, and
wherein said at least one infrared attenuating agent is substantially evenly distributed throughout said second polymer fibers.

22. The fibrous insulation product of claim 19, wherein said infrared attenuating agent is at least substantially evenly distributed throughout one or both of said first polymer fibers and said second polymer fibers.

23. The fibrous insulation product of claim 22, wherein said infrared attenuating agent is selected from graphite, nanographite, carbon black, powdered amorphous carbon, asphalt, granulated asphalt, milled glass, fiber glass strands, mica, black iron oxide, metal flakes, nanographene platelets, single walled carbon nanotubes, multi-walled carbon nanotubes, carbon nanofibers, activated carbon, metal oxides and combinations thereof.

24. The fibrous insulation product of claim 19, wherein said at least one infrared attenuating agent has a thickness in at least one dimension of less than about 100 nanometers.

25. The fibrous insulation product of claim 24, wherein said at least one infrared attenuating agent has a thickness in other dimensions of less than about 100 microns.

26. The fibrous insulation product of claim 19, wherein said insulation product further comprises at least one member selected from glass fibers, natural fibers, synthetic fibers, mineral fibers, carbon fibers, ceramic fibers, dual glass bicomponent fibers and polymer fibers.

27. A method of manufacturing a fiberglass insulation product comprising:
feeding a first polymer material and at least one infrared attenuating agent into a first extruder;
supplying a second polymer material to a second extruder; and
co-extruding said first polymer material and said at least one attenuating agent with said second polymer material to form said bicomponent fiber.

28. The method of claim 27, wherein said first polymer material and said at least one infrared attenuating agent form a sheath and said second polymer material forms a core.

29. The method of claim 27, further comprising:
compounding said at least one infrared attenuating agent in a polymer carrier;
pelletizing said compounded infrared attenuating agent to form a pellet; and
supplying said pellet and said polymer material to said first extruder at substantially the same time.

30. The method of claim 27, wherein said at least one infrared attenuating agent has a thickness in at least one dimension of less than about 100 nanometers.

31. The method of claim 27, further comprising:
adding to one of said first and second extruder at least one member selected from glass fibers, natural fibers, synthetic fibers, mineral fibers, carbon fibers, ceramic fibers and dual glass bicomponent fibers.
